(19) United States
(12) Patent Application Publication
(10) Pub. No.: US 2009/0196489 A1
(43) Pub. Date: Aug. 6, 2009

(54) HIGH RESOLUTION EDGE INSPECTION

(76) Inventor: Tuan D. Le, Minneapolis, MN (US)

Correspondence Address: DICKE BILLIG & CZAJA, PLLC;ATTN: CHRISTOPHER MCLAUGHLIN, 100 SOUTH FIFTH STREET, SUITE 2250, MINNEAPOLIS, MN, 55402, US

(21) Appl. No.: 12/362,683

(22) Filed: Jan. 30, 2009

Related U.S. Application Data
(60) Provisional application No. 61/024,810, filed on Jan. 30, 2008.
(60) Provisional application No. 61/048,169, filed on Apr. 26, 2008.

(51) Int. Cl. G06K 9/00

(52) U.S. Cl. 382/148

(57) ABSTRACT

Systems and methods of inspection for a substrate. At least two images of a selected portion of the substrate edge are captured using an optical imaging system, and each characterized by a discrete focal distance setting of the optical imaging system. A composite image of the substrate edge is formed from the at least two images. Defect(s) are identified in the composite image. Some optical systems can include at least one optical element having an optical power and a focusing mechanism for modifying a focal distance of the optical system.

### CROSS-REFERENCE TO RELATED APPLICATION

This application is related to and claims the benefit of U.S. Provisional Patent Application Ser. No. 61/024,810, filed on Jan. 30, 2008, and U.S. Provisional Patent Application Ser. No. 61/048,169, filed on Apr. 26, 2008, the teachings of which are incorporated herein by reference.

### TECHNICAL FIELD

The present invention relates generally to the inspection of high aspect ratio substrates such as semiconductor substrates, for example the inspection of the edge of such substrates and/or measurement of features on such substrates.

### BACKGROUND

As semiconductor devices shrink in size and grow in terms of speed and complexity, the likelihood that such devices may be damaged or destroyed by ever smaller defects rises. It is well understood that various processes and process variations may create defects such as chips, cracks, scratches, particles and the like, and that many of these defects may be present on an edge of a semiconductor substrate.

In general, semiconductor devices are formed on silicon wafers, also referred to herein as “substrates”. These wafers or substrates have edges with complex shapes such as chamfers, round-overs and curvilinear bevels. And, given that inspection systems using optical methods to locate defects on these edges operate at high levels of magnification, it can be hard to capture images of the edge of such substrates. Accordingly, multiple optical systems are often used to capture images of discrete portions of the substrate's edge. These images are then analyzed to identify defects. This information is then used to improve the yield of the semiconductor fabrication process.

Given the difficulties in imaging a semiconductor substrate edge, what is needed is a method and apparatus that allows all or substantially all of an edge of a semiconductor substrate to be imaged in high resolution, preferably in color and/or grayscale formats. Such an apparatus and/or technique should be capable of obtaining high resolution images of a substrate edge and individual features or defects on a substrate edge.

### BRIEF DESCRIPTION OF THE DRAWINGS

FIG. 1 is a schematic illustration of an optical system in accordance with principles of the present disclosure;

FIG. 2 is a flow diagram of an inspection process in accordance with the present disclosure;

FIG. 3 is a block diagram of one image fusion scheme useful with systems and methods of the present disclosure;

FIG. 4 is a schematic image of a wafer under inspection in accordance with the present disclosure; and

FIG. 5 is a schematic image of a wafer under inspection in accordance with the present disclosure.

### DETAILED DESCRIPTION

In the following detailed description, reference is made to the accompanying drawings that form a part hereof, and in which is shown, by way of illustration, specific embodiments in which aspects of the present disclosure may be practiced. In the drawings, like numerals describe substantially similar components throughout the several views. These embodiments are described in sufficient detail to enable those skilled in the art to practice aspects of the present disclosure. Other embodiments may be utilized and structural, logical, and electrical changes may be made without departing from the scope of the present disclosure. The following detailed description is, therefore, not to be taken in a limiting sense.

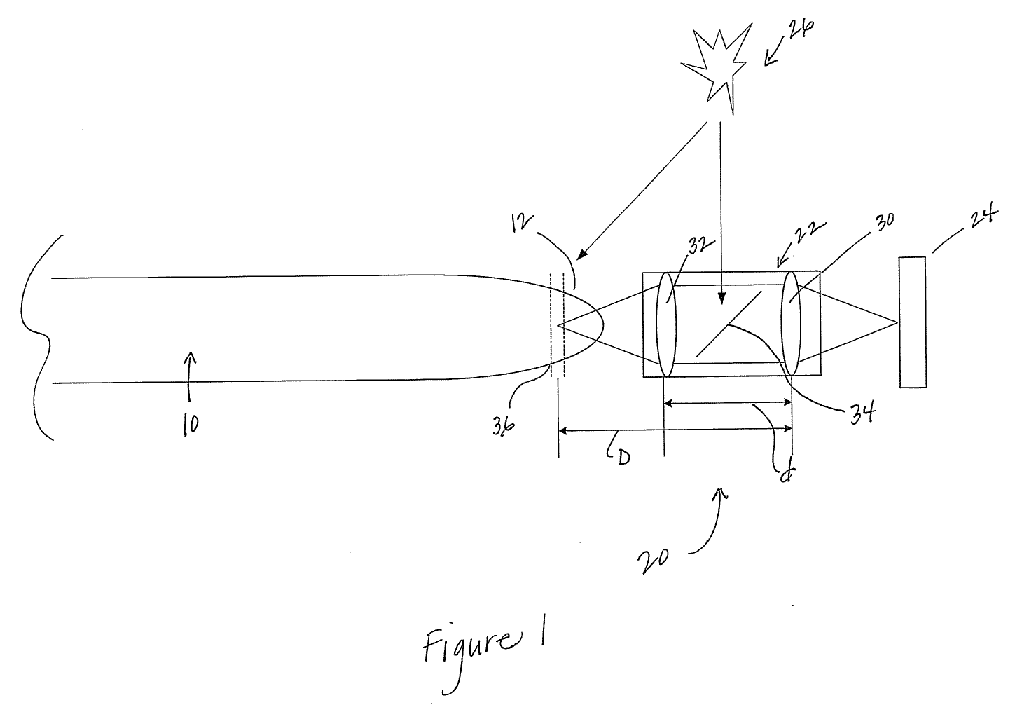

FIG. 1 illustrates one exemplary embodiment of an optical system 20 that may be configured to carry out the aims of the present disclosure. In FIG. 1, a wafer (or other high aspect ratio substrate) 10, and particularly its edge 12 are imaged by the optical system 20. The optical system 20 is arranged in this embodiment to image the edge 12 at a normal orientation thereto.

The optical system 20 represented in FIG. 1 is exemplary only and readily understood by those skilled in the art. Accordingly, the optical system 20 need not be described in great detail. The optical system 20 includes a lens arrangement 22, a sensor 24 and an illuminator 26. The illuminator 26 may be of any useful type, including bright field or dark field, and may further output poly- or mono-chromatic light in a continuous or intermittent (e.g., strobing) fashion. The lens arrangement 22 may be of any useful arrangement including diffractive and/or reflective lenses and/or other useful optical elements. In the embodiment illustrated in FIG. 1, the lens arrangement 22 includes a first lens element 30 and a second lens element 32. A beam splitter 34 may be positioned between the first and second lens elements 30, 32 to provide bright field illumination in a manner well known in the art. Taken together, the lens elements 30 and 32 form conjugate planes at the sensor 24 and wafer edge 12. As will be appreciated, the lens arrangement 22 defines a depth of field 36 at the conjugate plane at the wafer edge 12 such that those portions of the wafer edge 12 located within the depth of field 36 will be substantially in focus at the sensor 24. Modification of the lens arrangement 22 may move the depth of field 36 with respect to the wafer edge 12. For example, moving the second lens element 32 closer to the stationary first lens element 30 (i.e., reducing distance “d”), results in the depth of field 36 moving to the left in FIG. 1 (i.e., distance “D”) is increased. By modifying distance “d” between the first and second lens elements 30 and 32, the distance “D” is modified and a user of the optical system 20 may selectively position the depth of field 36 over substantially the entire wafer edge 12.

Sensor 24 may be a CCD, CMOS or other sensor and may operate in an area scan, line scan or point scan manner, as will be well understood by those skilled in the art. As will be appreciated, as lens arrangement 22 is modified to move the depth of field 36 across the wafer edge 12, care is taken to maintain the conjugate plane substantially at the sensor 24. In this manner, the image transmitted by the lens arrangement 22 remains substantially in focus.

Different arrangements of optical elements in the lens arrangement 22 can provide different depths of field 36. However, as a general rule, the greater the magnification or resolution of a lens arrangement 22, the thinner or narrower the depth of field. Accordingly, there is often a trade off in terms of resolution/magnification and depth of field. An optical system capable of capturing high resolution images, e.g., on the order of 0.5 microns and larger, will have a depth of field of between 1 and 250 microns. Note that the depth of field is highly dependent upon the optical elements that make up a given optical system and accordingly, the range given above should be treated as exemplary only and not limiting. Given that a wafer edge 12 may be about 200 to 300 microns in depth as measured in the normal direction illustrated in FIG. 1, it will be appreciated that only certain portions of the wafer edge 12 may be imaged, in focus, at any given time.

In the inspection of a wafer 10 for defects (or measurement of defects, identification and/or measurement of other features, etc.), it is important to use images that are in focus. This avoids or minimizes the likelihood that defects present on the wafer 10 will be missed or reported as present when no such defects actually exists. Further, in-focus images make it easier or even possible to identify important characteristics of defects present on the wafer 10. Because the high resolution images required for wafer defect inspection result in optical system arrangements having depths of field narrower or shallower than the entire surface to be imaged, one must either be satisfied with significant focus problems in a single image or multiple images may be required. Modifications of the lens arrangement 22 may be taken to minimize the limitations of the resolution/depth of field tradeoff, however such arrangements are difficult to achieve and in any case often become prohibitively expensive. Taking multiple images provides the in-focus images one needs for inspection purposes, but requires the review of multiple images.

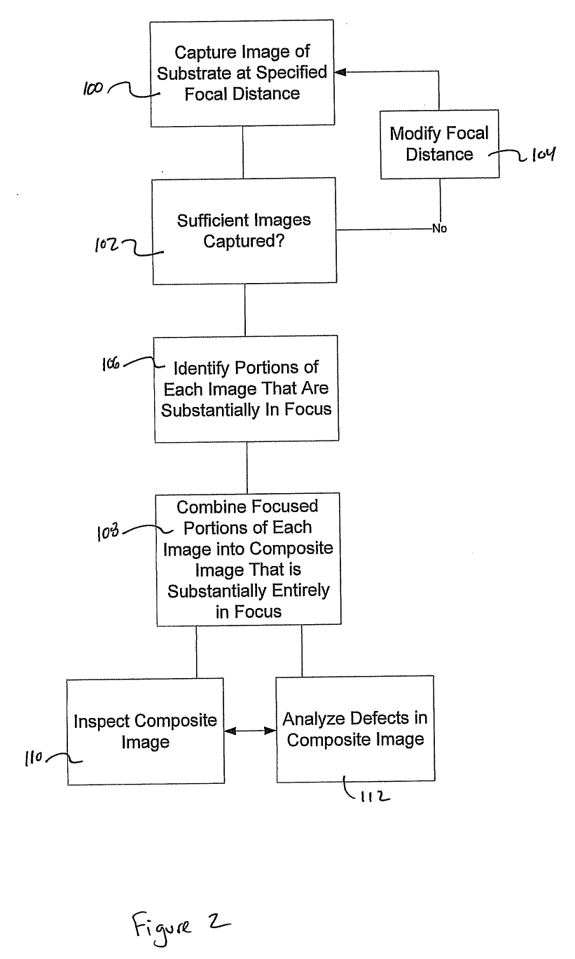

In accordance with the present disclosure, multiple images may be concatenated into a single composite image using image fusion techniques. Referring now to FIG. 2, it can be seen that one should capture sufficient images of an object at steps 100-104 such as the wafer edge 12 to ensure that substantially all of the area of the object being imaged is imaged in focus. For example, where the depth of field 36 of the optical system 20 is 75 microns and the object being imaged, in this case the wafer edge 12, is 250 microns in depth, approximately four images should be taken, each with a different focal distance D so that the depth of field is addressed sequentially to substantially the entire wafer edge 12. Overlap between the images is acceptable and in many cases desirable. Note that in the embodiment illustrated in FIG. 1, images captured by the sensor 24 will include an upper and a lower portion of the wafer edge 12 that are in focus. Various other surfaces can be imaged. For example, if the sensor 24 is angled at 45° to the edge 12, a portion of a topside and bevel of the edge 12 can be imaged; or the sensor 24 can be positioned to image a frontside and the bevel of the edge 12; etc.

Note that in some image fusion processes such as, for example, the embodiments discussed here, each of the multiple images is registered or aligned with one another, preferably on a pixel-by-pixel basis and to sub-pixel accuracy. It must be understood however, that the foregoing alignment requirement may relax under certain applications, the important aspect of image alignment being that the multiple images must be aligned to within a degree sufficient to successfully carry out the image fusion process as determined by a user of the inspection system, i.e., if the results of the process satisfy the user of the system, then by definition the alignment will have been sufficient. In one embodiment, the success of an image fusion process may be determined by imaging a three dimensional object having known features whose image may be analyzed to determine whether alignment was sufficient.

In one embodiment of an image fusion process, the multiple images are each analyzed to identify those portions of each image that are in focus at 106. This is generally achieved by identifying in each image those portions that have the best contrast values. One example of this identification step involves the calculation of edge transition width values or scores. In other words, potential edges are identified in an image using an edge detection routine and an edge transition width value for each of those edges is calculated. In other embodiments, intensity change gradients are determined and edges are identified in those areas where maximal intensity change gradients are found. For example, the rates of change of pixel intensity across one or more rows or columns of an electronic image are analyzed to identify local maxima which are identified as potential edges. Once potential edges are located, pixel growth algorithms may be used to ‘grow’ an edge by adding adjacent pixels that meet pixel intensity (or in some circumstances, color) requirements. In any case, once edges or edge regions are located, image fusion analyses can begin at 108.

In one embodiment of image fusion, multiple aligned images of the same field of view are compared, the one to the other, to determine which portions of each image of all of the images are in the ‘best’ focus. This is done by comparing pre-calculated edge transition widths or by comparing pre-calculated pixel intensity gradients. If these have not been calculated as part of the edge finding process, these values or some value of similar utility will be calculated for use in the comparison process. In general, larger edge transition widths or more gradual pixel intensity change gradients are indicative of image portions that are more out of focus as the edge represented by the aforementioned values or gradients will blurred over a wider area. Conversely, smaller edge transition widths and sharper pixel intensity change gradients are indicative of better focus.

In general, those areas having better focus are identified in each of the multiple aligned images and are copied to a new, blank image which will be a composite of the multiple aligned images. Alternatively, one of the multiple aligned images may be selected as having the best focus and areas of the remaining images indicated as having the ‘best’ focus will be copied and pasted over the corresponding areas of the selected image to form a composite image. The resulting composite images are substantially in focus over their entire field of view to within the resolution of the method used to identify the ‘best’ focus of the respective areas of the multiple images. Those skilled in the art will recognize that there are multiple methods for determining what areas of each of the multiple images are in the ‘best’ focus and that each of these methods has various strengths and weaknesses that may warrant their application in given settings. Regardless, the systems and method of the present disclosure do not require that all images be in focus; for example, two images can be employed whereby the area(s) of interest are in focus and everything else (in focus or out of focus) is ignored.

Once the composite image is generated, inspection of the wafer 10 and/or defect image capture may take place at 110 and 112. Inspection of the wafer 10 may be carried using a simple image-to-image comparison wherein differences between the two images are identified as potential defects. In this method, images of nominally identical areas of the wafer 10 are captured or rather composite images are prepared and the captured and/or composite images are compared to identify differences. Differences between the images that rise above a user defined threshold are flagged as defects or potential defects and their position and other information such as size, color, brightness, aspect ratio, etc., is recorded. Some differences identified in this comparison may not be considered defects based on additional user defined defect characteristics.

Another inspection method that may be used involves using multiple composite images to form a model of the wafer 10 against which subsequent composite images of the wafer 10 are compared. An example of this method is disclosed in U.S. Pat. No. 6,826,298 hereby incorporated by reference.

Another inspection method that may be used involves a statistical analysis between a model formed from composite images and subsequent composite images. An example of this inspection method is disclosed in U.S. Pat. No. 6,487,307, hereby incorporated by reference.

While the processes described above with respect to FIG. 2 relate, in part, to wafer or substrate inspection (e.g., Automatic Defect Classification), systems and methods in accordance with principles of the present disclosure are equally applicable to other aspects of substrate manufacturing (e.g., semiconductor fabrication) process(es). For example, the system and methods of the present disclosure can be employed with purely dark field inspection to increase sensitivity; with edge bead removal (EBR) metrology to better measure distances between the film transition and a reference point (e.g., wafer topside, which may otherwise be far away and out of focus) or relative to another film transition on the bevel; etc. In more general terms, then, systems and methods of the present disclosure are applicable for identifying and/or measuring defects as well as (or alternatively) other substrate features (e.g., bumps, probe mark inspection (PMI), vias, etc.) of high aspect ratio substrates such as semiconductor wafer substrates.

As an alternative or in addition to inspection, composite images can be used for defect or other feature image capture and review purposes (e.g., measurement). In many cases, identified defects must be analyzed, either manually or automatically, to identify the type or source of a defect. This typically requires high resolution images as many of the defect characteristics used to identify the defect can be subtle. Using a composite image allows for high resolution defect image capture and further allows all defects (or other features) to be viewed simultaneously in high resolution. This is useful in that additional characteristics may be extracted or existing characteristics of defects or other features may be obtained in greater confidence. The systems and methods of the present disclosure are effective in suppressing noise, thus increasing sensitivity of obtained information.

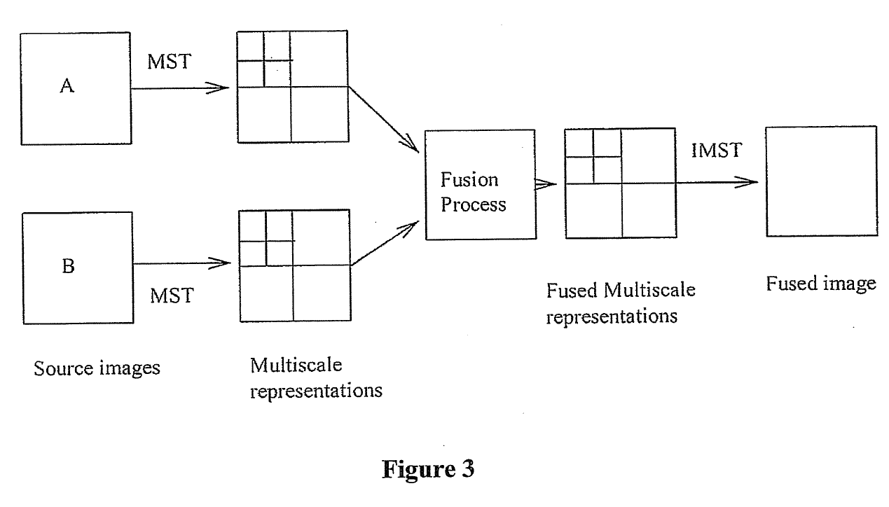

Image fusion (e.g., a process that generates a single, synergized image from two or more source images, such that the fused image provides or entails a more accurate representation or description of the object (or selected portion(s) of the object) being imaged than any of the individual source images) in accordance with aspects of the present disclosure can be accomplished as described above and/or in accordance with other techniques. These include, for example, image mean, square root method, multiscale image decomposition, pyramids (e.g., Gaussian Pyramid, Laplacian Pyramid, etc.), difference image, etc. One non-limiting representation of image fusion using multiscale image decompositions is shown in FIG. 3. A multiscale transform (MST) is performed on each of two source images. Then, a composite multiscale representation is constructed from this based on certain criteria. The fused image is then obtained by taking an inverse multiscale transform.

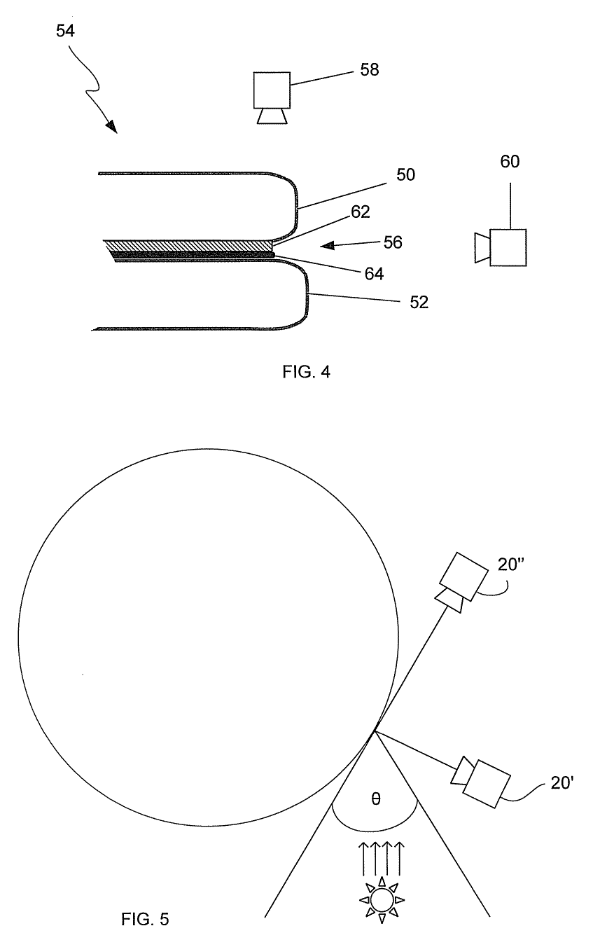

One application for which edge inspection utilizing fused images may be useful is for the inspection of the edge of stacked wafers as shown in FIG. 4. In many semiconductor products, wafers having semiconductor devices formed thereon must be thinned or ground down after the devices have been formed on a top side thereof. In through silicon via (TSV) applications, the back thinning process is used to either expose pre-existing vias or allow for drilling of vias. If there are chips or cracks on a wafer's edge, mechanical stress exerted during the back thinning process can cause the edge chips and cracks to propagate, resulting in a broken wafer. This wafer breakage can be monitored and prevented by inspecting the wafer edge before and after back thinning for edge chips and cracks. In addition to edge chips, adhesive layer protrusion can also be detected.

One method for securely holding a wafer 50 that is to be thinned is to affix it to a carrier wafer 52. As will be appreciated, inspection of such a stack 54 of wafers and particularly the edge thereof can be difficult. Edge top cameras 58 such as that shown in FIG. 4 cannot capture images of the interstitial zone 56 where the semiconductor devices 62 and the adhesive 64 used to secure the device wafer 50 to the carrier wafer 52 are located. Note that FIG. 4 is a schematic illustration and that the dimensions of the wafers, adhesive and semiconductor devices 62 formed on wafer 50 are not to scale. Further, illumination located above the plane of the wafer 50 with devices formed thereon will likely cast a shadow on the interstitial space 56 between the wafers.

Illumination of an edge of the stacked wafers 54 is provided by source 70 which may be arranged as a brightfield or darkfield illuminator. As seen in FIG. 5, source 70 may be a darkfield illuminator with respect to optical system 20′ and a brightfield illuminator with respect to optical system 20″. The illumination provided by the source 70 is preferably in the plane of the stacked wafers 54 such that the illumination, whether bright or darkfield, is incident on substantially the entire edge of the stacked wafers 54 that is being viewed or imaged, including on the interstitial space 56. Note that illumination may be broadband, monochromatic and/or laser in any useful combination, wavelength or polarization state, including visible light, ultraviolet and infrared. Multiple locations for illumination sources are possible.

It is possible to locate illumination sources 70 out of the plane of the stacked wafers 54 (above or below) so long as sufficient illumination is incident on the edge of the stacked wafers 54. It will be appreciated that the exact angle or position above or below the plane of the stacked wafers 54 will depend on the geometry of the edge thereof. The use of one or more diffusers (not shown) positioned adjacent or partially circumjacent to the stacked wafer edge may facilitate the illumination of the edge of the stacked wafers by directing both bright and darkfield illumination onto the stacked wafer edge simultaneously.

As seen in FIG. 5, optical systems 20 may be disposed about a portion of an edge of the stacked wafers 54 to capture images thereof. Optical system 20′ has an optical axis 21 that is positioned substantially normal to the edge of the stacked wafers 54. In other embodiments, optical system 20′ may be positioned at an angle to the normal plane of the wafer edge. Where an optical system 20′ is positioned at such an angle, the optical system 20′ may be provided with optical elements (not shown) to help satisfy the Scheimpflug condition. The optical system 20′ is particularly useful for capturing images of the edge of the stacked wafers 54 as described in conjunction with FIGS. 1-3. This same optical system 20′ may be rotated to the position of optical system 20″ or a separate optical system 20″ may be provided to capture images of the edge of the stacked wafers 54 in profile.

Using one or both optical systems 20′ and 20″, one may capture images useful for inspecting the edge of the stacked wafers 54. In one embodiment, the captured images, fused images or unmodified images, may be analyzed by laterally compressing the images and then concatenating the compressed images into a single image or groups of images that represent the entire or selected contiguous regions of the edge of the stacked wafers 54. Edges are located using any of a number of edge finding techniques such as canny edge finding filters and then extended across the entire concatenated image by fitting identified edge segments to a suitable model. In the case of a series of images of the edge of stacked wafers 54 taken from an optical system 20 positioned within or very near the plane of the stacked wafers 54, the preferred model may be a straight line. Note that where the periphery of the stacked wafers 54 is not flat, the composite or unmodified images or their compressed counterparts may be vertically aligned by finding a known feature, such as a top or bottom edge of the stacked wafers 54, and shifting the images so as to align the selected feature across the concatenated images. Once the boundaries between the wafers 50, 52 and the adhesive that bonds them is identified in the concatenated images, the position of those boundaries may be extrapolated or located directly using pixel concatenation or edge finding means that use the location of the boundaries in the concatenated images as a starting point. This technique is more completely described in US Patent Application No. 2008/0013822, published Jan. 17, 2008 and hereby incorporated by reference.

The profile of the wafer stack 54 may be analyzed and assessed by using standard image processing techniques such as blob analysis and the like. Images captured by optical system 20″ will show the profile of the stack 54 in fairly strong contrast owing to the fact that light from source 70 back lights the profile of the stack 54 to a useful degree. In one embodiment a simple thresholding operation separates the stack 54 from the background and thereafter, the individual wafers in the stack 54 are separated using a combination of pre-defined nominal thicknesses and edge finding techniques. In one embodiment, a top edge and a bottom edge of the thresholded image are identified and the total thickness of the stack is determined based on a conversion of pixels to distance. Thereafter, the edges of the profile of the thresholded image are grown or identified and extrapolated so as to define a location for a boundary between the stacked layers. Alternatively, where the overall thickness of the stack falls outside of a predetermined range, the excursion will be noted. The shape of the wafer stack may also be compared to a nominal shape to identify excursions. Other means for analyzing the geometry of profile of the edge of the wafer stack 54 will be apparent to those skilled in the art.

This technique of inspecting the edges of stacked wafers may be used on stacks of wafers having two or more wafers in the stack. In one embodiment, distances between stacked wafers around all or a selected portion of the periphery of the stack may be determined either from an analysis of the profiles of the stacked wafers or by identifying boundaries between the stacked wafers. Similarly, thicknesses of the adhesive may be obtained by measuring distances between stacked wafers as seen in profile or by identifying boundaries between the stacked wafers and/or layers of adhesive. By measuring or determining the dimensions of a stacked wafer, discontinuities in the wafer stack including uneven wafer edge thicknesses, uneven adhesive thicknesses (due to errors in adhesive application or to the inclusion of debris between wafers), or misalignment of the respective wafers in a stack may be readily identified. In addition to dimensional excursions, chips, cracks, particles and other damage to the single or stacked wafers may be identified. The use of edge finding techniques as described above may in some instances be useful for identifying edge bead removal lines or evidence on multiple stacked wafer edges, sequentially or simultaneously. Further, where adhesive or other materials form a film or have otherwise affected the edge of the stacked wafers, these excursions may easily be identified.

Although specific embodiments of the present disclosure have been illustrated and described herein, it will be appreciated by those of ordinary skill in the art that any arrangement that is calculated to achieve the same purpose may be substituted for the specific embodiments shown. Many adaptations of the disclosure will be apparent to those of ordinary skill in the art. Accordingly, this application is intended to cover any adaptations or variations of the disclosure.

What is claimed is:

1. A method of inspection for a substrate, such as an edge of a substrate having a top bevel surface, a normal surface, and a bottom bevel surface, the method comprising:
capturing at least two images of a selected portion of the substrate edge using an optical imaging system, each of the at least two images being characterized by a discrete focal distance setting of the optical imaging system;
forming a composite image of the substrate edge from the at least two images; and
identifying defects in the composite image of the substrate edge.

2. The method of inspection of claim 1, wherein the optical imaging system has a predetermined focal depth and wherein the capturing of images of the selected portion of the substrate edge is performed sufficient times such that substantially the entire area of the substrate edge is imaged at least once within the focal depth of the optical imaging system.

3. The method of inspection of claim 1, further comprising:
capturing a series of images at a corresponding series of focal distances wherein the focal distances of each of the series of images are arranged such that a depth of field of the optical imaging system is addressed to substantially the entire substrate edge.

4. The method of inspection of claim 3, further comprising:
forming a composite image using those portions of each of the series of images that are substantially in focus.

5. The method of inspection of claim 1, wherein each of the at least two images are substantially registered with one another in a pixel-by-pixel basis.

6. The method of inspection of claim 2, wherein the focal distance of the optical imaging system is modified as the substrate rotates with respect to the optical imaging system in a manner selected from a group consisting of stepwise and continuous.

7. A semiconductor device manufactured by a process including an edge inspection step which comprises:
capturing at least two images of a selected portion of a substrate, such as a substrate edge, using an optical imaging system, each of the at least two images being characterized by a discrete focal distance setting of the optical imaging system;
forming a composite image of the substrate edge from the at least two registered images;
identifying a defect, if any, in the composite image of the substrate edge;
classifying an identified defect;
correlating a classified defect as to at least one root cause; and
modifying at least one semiconductor fabrication process to minimize a likelihood of recurrence of the identified defect by modifying the at least one root cause.

8. The semiconductor device manufactured by a process including an edge inspection step of claim 7, further comprising:
forming a composite image using those portions of each of the series of images that are substantially in focus.

9. The semiconductor device manufactured by a process including an edge inspection step of claim 7, wherein the substrate comprises, at least one point during the process, a plurality of wafers bonded to one another in a stack.

10. An optical inspection system for inspecting an edge of a substrate comprising:
a substrate support for supporting and rotating the substrate;
an illumination system for illuminating at least a selected portion of the substrate;
an optical system for collecting light from the illumination system returned from the selected portion of the substrate and transmitting the collected light, the optical system comprising at least one optical element having an optical power and a focusing mechanism for modifying a focal distance of the optical system;
an imaging device for receiving the transmitted collected light and forming an image therefrom; and
a processor for receiving the image from the imaging device.

11. The optical inspection system for inspecting an edge of a substrate of claim 10 wherein the processor is coupled to the focusing mechanism of the optical system and is adapted to modify a focal distance of the optical system so as to permit the capture, by the imaging device, of at least two registered images of the selected portion of the substrate, the processor being further adapted to operate software for to identifying those portions of the at least two images that are substantially in focus and for concatenating those portions of the at least two images to form a composite image of the substrate.

12. The optical inspection system for inspecting an edge of a substrate of claim 11, wherein the optical system is situated so as to capture an image of a profile of the substrate.

13. The optical inspection system for inspecting an edge of a substrate of claim 12, wherein the optical system captures in image of a plurality of substrates simultaneously.

14. A method of classifying defects on a substrate, such as a substrate edge, having a top bevel surface, a normal surface, and a bottom bevel surface, the method comprising:
identifying defects in the composite image of the substrate edge and recording a location of the defects, if any;
capturing at least two registered images of a defect on the substrate edge, if any;
concatenating at least portions of the at least two registered images to form a composite image, the portions of the at least two registered images including at least portions of the locations within the image where a defect is found and further wherein the defect is substantially in focus;
extracting at least one characteristic of a defect from the composite image; and
assigning an identification to a defect based on the at least one extracted characteristic of the defect.

15. A method of inspecting a stacked semiconductor substrate comprising:
acquiring a plurality of images about an edge portion of a stacked semiconductor substrate, each of the images comprising an array of pixels having a lateral dimension and a vertical dimension;
generating a composite image of compressed pixel arrays by:
compressing each of the pixel arrays in the lateral dimension;
aligning each of the pixel arrays in the vertical dimension; and
concatenating the pixel arrays to form a single array;
analyzing the composite image to identify at least one boundary between a first wafer and a second wafer of the stacked semiconductor substrate.
